(19) United States
(12) Patent Application Publication
(10) Pub. No.: US 2008/0189195 A1
(43) Pub. Date: Aug. 7, 2008

(54) SYSTEM AND METHOD FOR ACCOUNT RECONCILIATION

(75) Inventors: XUE-JUN XIA, Shenzhen (CN); XIAO-DONG CHEN, Shenzhen (CN); WAI-SING-WINSLOW FOR, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/020,572

(22) Filed: Jan. 27, 2008

(30) Foreign Application Priority Data
Feb. 2, 2007 (CN) 200710200150.7

(51) Int. Cl. G06Q 10/00

(52) U.S. Cl. 705/30

(57) ABSTRACT

An account reconciliation system (1000) includes a data gathering subsystem (1100) and a reconciliation data processing subsystem (1200). The data gathering subsystem is provided for gathering data. The reconciliation data processing subsystem includes a data importing module (1210) for importing the gathered data and the payment data, and a data comparing module (1230) for comparing the gathered data with the payment data to differentiate items with unmatched key information and items with matched key information as well as unmatched sale information therein, and storing the items with the unmatched key information in a missing table, storing the items with the matched key information incorporated with the unmatched sale information in an exception table. The accounts reconciliation system automatically reconciles the gathering account and the payment account by employing the data gathering subsystem and the reconciliation data processing subsystem. A method for account reconciliation is also provided.

### BACKGROUND

1. Field of the Invention

The present invention relates to systems and methods for processing data, and particularly to a system and method for account reconciliation.

2. Description of Related Art

Logistics flow, funds flow, and business flow hold more and more important positions in modern enterprise management. Management efficiency of an enterprise can be improved by efficient account reconciliation of goods and funds transactions, especially when the enterprise is involved in multi-transactions. Conventional account reconciliation procedure is that one party of a transaction sends detailed reconciliation statements to the other party, or stores the detailed reconciliation statements at an appointed place for the other party to access or retrieve; and the other party will respond with a receipt to the one party when the reconciliation statements are certified as correct.

Traditional reconciliation procedures require manual operation and analysis to discover discrepancies if any, for which an experienced financial operator and a great amount of time are needed, and may lead to human error.

### SUMMARY

An exemplary embodiment of the present invention provides an account reconciliation system. The account reconciliation system includes a data gathering subsystem and a reconciliation data processing subsystem. The data gathering subsystem is provided for gathering data. The reconciliation data processing subsystem includes a data importing module and a data comparing module. The data importing module is provided for importing the gathered data and payment data. The data comparing module is provided for comparing the gathered data with the payment data to differentiate items with unmatched key information and items with matched key information as well as unmatched sale information therein, and storing the items with the unmatched key information in a missing table, storing the items with the matched key information along with unmatched sale information in an exception table.

Another exemplary embodiment of the present invention provides a method for account reconciliation comprising further steps: initiating data gathering via the data gathering subsystem; importing gathered data via the reconciliation data processing subsystem; importing payment data via the reconciliation data processing subsystem; comparing the gathered data with the payment data to differentiate items with unmatched key information and items with matched key information as well as unmatched sale information; storing items with the unmatched key information in the missing table, storing items with the matched key information along with the unmatched sale information in the exception table.

Other objects, advantages and novel features of the present invention will be drawn from the following detailed description of a preferred embodiment and a preferred method with the attached drawings, in which:

### BRIEF DESCRIPTION OF THE DRAWINGS

FIG. 1 is a schematic diagram of an application environment of an account reconciliation system in an embodiment of the present invention;

FIG. 2 is a flowchart of a method for account reconciliation in another embodiment of the present invention;

FIG. 3 is a detailed flowchart of FIG. 2; and

FIG. 4 is a flowchart after a node A of FIG. 3.

### DETAILED DESCRIPTION OF THE EMBODIMENTS

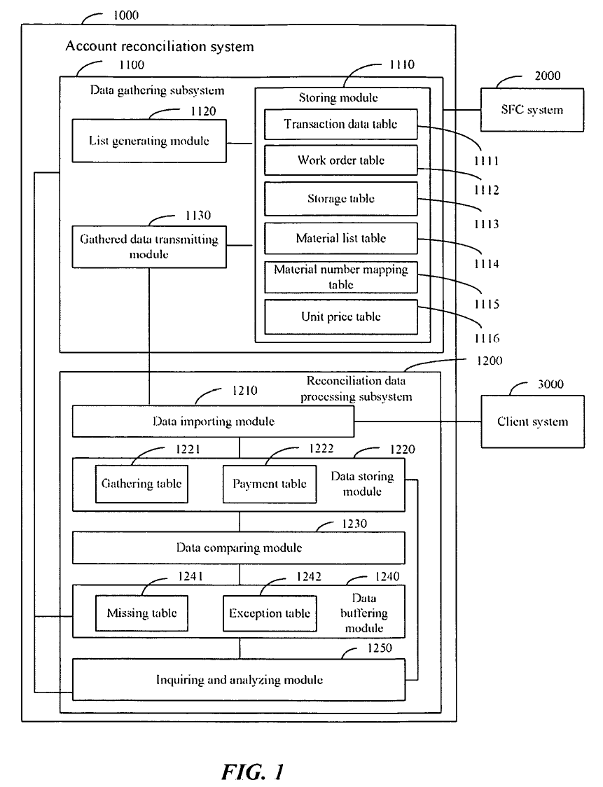

FIG. 1 is a schematic diagram of an application environment of an account reconciliation system 1000 according to an embodiment of the present invention. In this embodiment, the account reconciliation system 1000 is applied in a data processing system that further includes a Shop Floor Control (SFC) system 2000 and a client system 3000. The SFC system 2000 and the client system 3000 can communicate with the account reconciliation system 1000.

The SFC system 2000 is provided for transmitting transaction data to the account reconciliation system 1000. In this embodiment, the transaction data may be shipment data or rejection data, which includes but is not limited to a carton identifier (ID), product quantity, a machine model, a work order number, a shipment plant identifier (ID), a shipment date, a sale type, and so on. In practice, products of a plant are shipped to or kicked back by a client in carton units. Generally, the carton ID specifies a number of a packing carton, the product quantity specifies the quantity of the packed products in the packing carton, the machine model specifies a product type, the work order number specifies a corresponding work order number of the product, the plant ID specifies the plant name, the shipment date specifies the date on which the product is shipped to the client, and the sale type specifies whether the products are accepted or rejected by the client.

In other embodiments, the transaction data may include other relevant information according to different requirements.

The client system 3000 is an automatic payment system of the client, which includes payment data of the client. In this embodiment, the payment data are payment records for material usage, which include a carton ID, a plant ID, a sale type, a material number, and a unit price for payment.

In other embodiments, the payment data may also include different information according to different requirements.

In this embodiment, the account reconciliation system 1000 includes a data gathering subsystem 1100 and a reconciliation data processing subsystem 1200. The data gathering subsystem 1100 is a component of an Enterprise Resource Planning (EPR) system of the plant. The reconciliation data processing subsystem 1200 is a component of a data warehouse system of the plant.

In this embodiment, the account reconciliation system 1000 gathers data via the data gathering subsystem 1100, then the reconciliation data processing subsystem 1200 imports the gathered data from the data gathering subsystem 1100 and imports payment data from the client system 3000, and compares the gathered data with the payment data to differentiate items with unmatched key information, and items with matched key information incorporated with unmatched sale information therein, and stores items with the unmatched key information in a missing table, and stores items with the matched key information incorporated with the unmatched sale information in an exception table. In this embodiment, the key information includes the carton ID, the plant ID, the material number, and the sale type. The sale information includes the unit price and the material quantity. Therefore, the account reconciliation system 1000 automatically reconciles the gathered data and the payment data by employing the data gathering subsystem 1100 and the reconciliation data processing subsystem 1200.

The data gathering subsystem 1100 is provided for gathering data, and includes a storing module 1110, a list generating module 1120, and a gathered data transmitting module 1130.

The storing module 1110 includes but is not limited to a transaction data table 1111, a work order table 1112, a storage table 1113, a material list table 1114, a material number mapping table 1115, and a unit price table 1116. The storing module 1110 receives transaction data from the SFC system 2000, and stores the transaction data in the transaction data table 1111. The work order table 1112 includes the material number and material quantity of each product. The storage module 1113 includes material information on the plant. The material list table 1114 is provided for storing a material account list. In this embodiment, the material account list includes a material backflush list and a returned material list. The material number mapping table 1115 shows a material number mapping relationship between the plant and the client. The unit price table 1116 is provided for storing the unit price for each product.

The list generating module 1120 is provided for processing a material account according to the transaction data, and generating the material account list. In this embodiment, the list generating module 1120 retrieves the transaction data from the transaction data table 1111 at first, and then inquires about the material number and the material quantity of each product in the work order table 1112 according to the work order number in the transaction data table 1111. Subsequently, the list generating module 1120 processes the material account in the storage module 1113 to generate the material account list based on the sale type, the inquired material number, and material quantity in the transaction data table 1111. In this embodiment, the material account list includes the material backflush list and the returned material list.

When the sale type is a shipment type, the list generating module 1120 processes material backflush in the storage module 1113 based on the shipment type, the product quantity, the inquired material number and the inquired material quantity, and generates a material backflush list. In this embodiment, the list generating module 1120 evaluates the material number and quantity for a carton of products according to the product quantity and the inquired material number and the material quantity, and then subtracts the material number and material quantity of a carton of products from the storage table 1113, and then generates a corresponding material backflush list.

When the sale type is a rejection type, the list generating module 1120 processes returned material in the storage module 1113 based on the rejection type, the product quantity, the inquired material number, and the material quantity, and generates a returned material list. In this embodiment, the list generating module 1120 evaluates the material number and the material quantity for a carton of products based on the product quantity and the inquired material number and material quantity, and then adds the material number and material quantity of a carton of products into the storage table 1113, and generates a corresponding returned material list.

Then, the list generating module 1120 stores the material account list in the material list table 1114.

The gathered data transmitting module 1130 is provided for reading the gathered data from the transaction data table 1111 and the material list table 1114 of the storing module 1110, and transmitting the gathered data to the reconciliation data processing subsystem 1200. In this embodiment, the gathered data are records on plant material usage which include the carton ID, the shipment plant ID, the sale type, the material number, the material quantity, and the unit price. The gathered data transmitting module 1130 reads the carton ID, the shipment plant ID, and the sale type from the transaction data table 1111, and reads the material quantity and material number from the material list table 1114. Then the gathered data transmitting module 1130 updates the material number according to the material number mapping table 1115, and reads the unit price from the unit price table 1116 based on the shipment date and the material number. At last, the gathered data transmitting module 1130 transmits the gathered data including the read carton ID, the shipment plant ID, the sale type, the material number, and the material quantity to the reconciliation data processing subsystem 1200.

Generally, parts of the material numbers of the plant and the client are not uniform. In this embodiment, the data gathering subsystem 1100 processes relevant data in two phrases: firstly, generating a material account list via the list generating module 1120, and storing the material account list in the material list table 1114; secondly, reading the material number from the material list table 1114 via the gathered data transmitting module 1130. In this way, the gathered data transmitting module 1130 automatically transforms the material number of the plant to the material number of the client according to the material number mapping module 1115, and then automatically reconciles the gathered data and the payment data.

For example, a packing carton includes a box and several fixing blocks. The material number of the client is the packing carton material number; the material number of the plant includes the box material number as well as the fixing blocks material number. The gathered data transmitting module 1130 automatically converts the box material number and the fixing blocks material number of the plant to the carton material number of the client according to the number mapping table 1115.

The reconciliation data processing subsystem 1200 includes a data importing module 1210, a data storing module 1220, a data comparing module 1230, a data buffering module 1240, and an inquiring and analyzing module 1250.

The data storing module 1220 includes a gathering table 1221 and a payment table 1222.

The data importing module 1210 is provided for importing the gathered data from the data gathering subsystem 1100 and for importing the payment data from the client system 3000. In this embodiment, the data importing module 1210 imports the gathered data including the carton ID, the shipment plant ID, the sale type, the material number and material quantity, and the unit price from the gathered data transmitting module 1130, and stores the gathered data in the gathering table 1221. The data importing module 1210 imports the payment data including the carton ID, the shipment plant ID, the sale type, the material number and material quantity, and the unit price from the client system 3000 by known business to business (B2B) means, and then stores the payment data in the payment table 1222.

The data buffering module 1240 includes a missing table 1241 and an exception table 1242.

The data comparing module 1230 is provided for comparing the payment data with the gathered data, to differentiate items with unmatched key information and items with matched key information as well as unmatched sale information, and for storing the items with the unmatched key information in the missing table 1241, and storing items with the matched key information incorporated with the unmatched sale information in the exception table 1242. In this embodiment, the key information includes the carton ID, the shipment plant ID, the material number and the sale type. The sale information includes the unit price and the material quantity.

In other embodiments, the key information may include different information based on different requirements.

The data comparing module 1230 determines whether the carton ID, the shipment plant ID, the material number and the sale type of the gathered data match with those of the payment data. When the data on an item in the gathered data, which include the carton ID, the shipment plant ID, the material number, and the sale type match with those of a corresponding item in the payment data, the data comparing module 1230 determines that the key information of the two items are matched.

When one or more of the data on the item in the gathered data which include the carton ID, the shipment plant ID, the material number and the sale type does not match with those of the corresponding item in the payment data, the data comparing module 1230 determines that the item in the gathered data is an item with unmatched key information, and stores the item in the gathered data in the missing table 1241.

Similarly, when one or more of the data on an item in the payment data which include the carton ID, the shipment plant ID, the material number and the sale type does not match a corresponding item in the gathered data, the data comparing module 1230 determines that the item in the payment data is the item with the unmatched key information, and then stores the item in the payment data in the missing table 1241.

And then, the data comparing module 1230 determines whether sale information on the items with the matched key information in the gathered data matches corresponding items in the payment data. When the unit price and the material quantity of the items are matched, the data comparing module 1230 determines that the items are items with the matched key information and matched sale information, and then marks the items as normal respectively in the gathering table 1221 and the payment table 1222. Otherwise, the data comparing module 1230 determines that the items are items with the matched key information along with unmatched sale information, and marks the items as abnormal respectively in the gathering table 1221 and the payment table 1222, and then stores the items in the exception table 1242.

In other embodiments, the data comparing module 1230 may only mark items with the matched key information and sale information as normal in the gathering table 1221 and the payment table 1222, or may only mark items with the matched key information along with the unmatched sale information as abnormal in the gathering table 1221 and the payment table 1222.

The data buffering module 1240 is provided for feeding unreconciled differences in data (difference data) in the missing table 1241 and the exception table 1242 back to the data gathering subsystem 1100 as a reference for data correction for the data gathering subsystem 1100.

The inquiring and analyzing module 1250 is used for inquiring about data in the gathering table 1221 and data in the payment table as well in the data storing module 1220 and difference data in the data buffering module 1240. The users can compare the difference data via the inquiring and analyzing module 1250, and feed the difference data back to the data gathering subsystem 1100 to furnish reference to the data gathering subsystem 1100 for data correction.

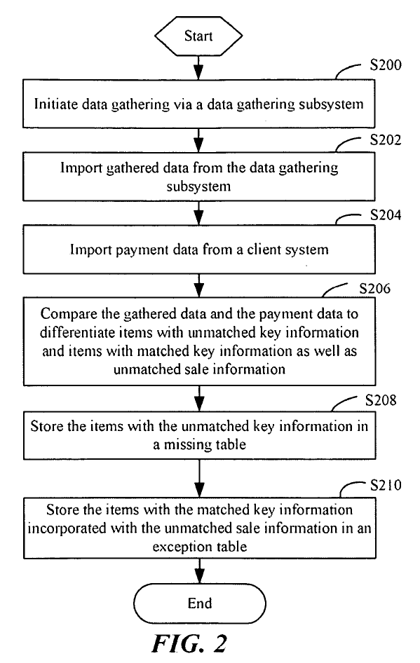

FIG. 2 is a flow-chart of a method for account reconciliation in accordance with an exemplary embodiment of the present invention.

In step S200, the data gathering subsystem 1100 initiates data gathering.

In step S202, the account reconciliation system 1200 imports the gathered data from the data gathering subsystem 1100.

In step S204, the account reconciliation system retrieves payment data from the client system 3000.

In this embodiment, the executive sequences from step S202 to step S204 are not restricted. Step S202 and S204 can be executed at the same time or in turns.

In step S206, the reconciliation data processing subsystem 1200 compares the gathered data with the payment data to differentiate items with unmatched key information and items with matched key information as well as unmatched sale information.

In step S208, the reconciliation data processing subsystem 1200 stores the items with the unmatched key information in the missing table 1241.

In step S210, the reconciliation data processing subsystem 1200 stores the items with the matched key information incorporated with the unmatched sale information in the exception table 1242.

Therefore, the account reconciliation system 1000 automatically reconciles the gathered data and the payment data by employing the data gathering subsystem 1100 and the reconciliation data processing subsystem 1200.

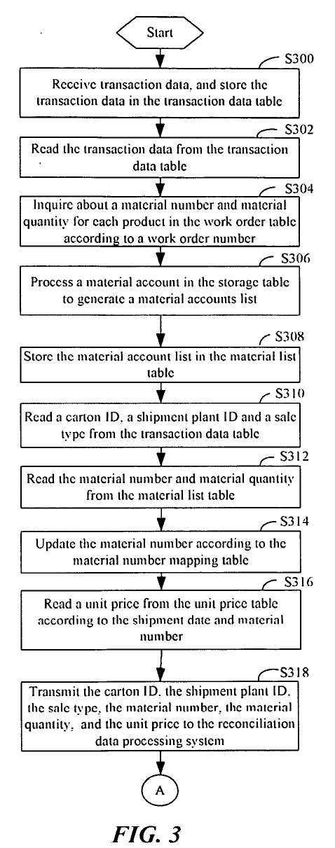

FIG. 3 is a detailed flow-chat of FIG. 2.

In step S300, the storing module 1110 of the data gathering subsystem 1100 receives transaction data from a SFC system 2000, and stores the transaction data in the transaction data table 1111.

In step S302, the list generating module 1120 reads the transaction data from the transaction data table 1111.

In step S304, the list generating module 1120 inquires about a material number and material quantity for each product based on a work order number in the work order table 1112.

In step S306, the list generating module 1120 processes a material account in the storage table 1113 according to a sale type as well as product quantity of the transaction data and the inquired material number, and material quantity, and then generates a material account list. In this embodiment, the material account list includes a material backflush list and a returned material list.

When the sale type is a shipment type, the list generating module 1120 processes material backflush in the storage module 1113 according to the shipment type, the product quantity and the inquired material number and material quantity, and then generates the material backflush list. When the sale type is a rejection type, the list generating module 1120 processes returned material in the storage module 1113 according to the rejection type, the product quantity, and the inquired material number and material quantity, and then generates the returned material list.

In sum, step S302 to step S306 describe how the list generating module 1120 processes accounts according to the transaction data and then generates the material account list.

In step S308, the list generating module 1120 stores the material account list in the material list table 1114.

In step S310, the gathered data transmitting module 1130 reads a carton ID, a shipment plant ID and the sale type from the transaction data table 1111.

In step S312, the gathered data transmitting module 1130 reads the material number and material quantity from the material list table 1114.

In step S314, the gathered data transmitting module 1130 updates the material number according to the material number mapping table 1115. In this embodiment, a part of the plant material number does not match a corresponding part of the client material number, the gathered data transmitting module 1130 then automatically transforms the unmatched material number of the plant to the material number of the client for further automatic reconciliation between the gathered data and the payment data.

In step S316, the gathered data transmitting module 1130 reads a unit price from the unit price table 1116 according to a shipment date and the material number.

In step S318, the gathered data transmitting module 1130 transmits the gathered data including the carton ID, the shipment plant ID, the sale type, the material number and the unit price to the reconciliation data processing subsystem 1200.

In sum, step S310 to step S318 describe the steps of how the gathered data transmitting module 1130 reading the gathered data from the storing module 1110, and transmitting the gathered data to the reconciliation data processing subsystem 1200.

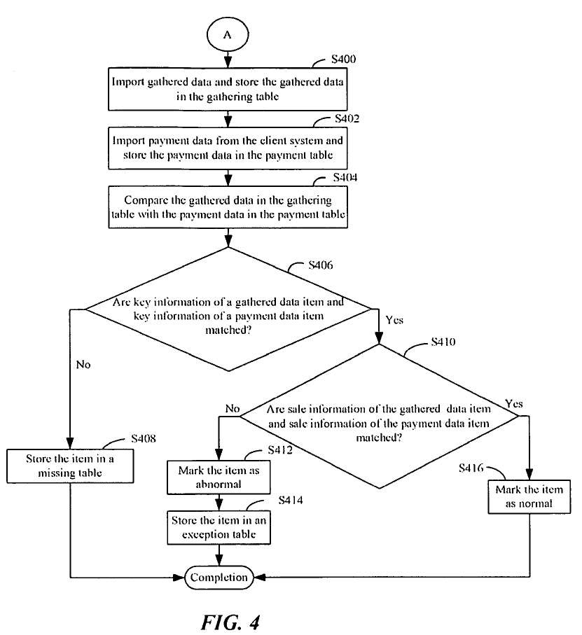

FIG. 4 is a flow-chat after a node A of FIG. 3.

In step S400, the data importing module 1210 of the reconciliation data processing subsystem 1200 imports gathered data from the data gathering module 1100, and stores the gathered data in the gathering table 1221. In this embodiment, the data importing module 1210 imports the gathered data which include a carton ID, a shipment plant ID, a sale type, material quantity, a material number, and a unit price from the gathered data transmitting module 1130, and then stores the gathered data in the gathering table 1221.

In step S402, the data importing module 1210 imports payment data from the client system 3000, and stores the payment data in the payment table 1222. In this embodiment, the data importing module 1210 imports the payment data which include the carton ID, the shipment plant ID, the sale type, the material number, the material quantity, and the unit price from the client system 3000 by a known (B2B) means, and then stores the payment data in the payment table 1222.

In step S404, the data comparing module 1230 compares the gathered data in the gathering table 1221 with the payment data in the payment table 1222.

In step S406, the data comparing module 1230 identifies whether key information of the gathered data and key information of the payment data are matched. In this embodiment, the key information includes the carton ID, the shipment plant ID, the material number, and the sale type. The data comparing module 1230 compares each item which include the carton ID, the shipment plant ID, the material number, and the sale type in the gathered data with each corresponding item in the payment data. When the carton ID, the shipment plant ID, the material number, and the sale type of an item in the gathered data match with those of a corresponding item of the payment data, the data comparing module 1230 determines that the key information of the two items are matched.

When the carton ID, the shipment plant, the material number and the sale type of an item in the gathered data does not match with those of a corresponding item in the payment data, the data comparing module 1230 determines the that the key information of the two items are not matched.

Similarly, When the carton ID, the shipment plant ID, the material number and the sale type of an item in the payment data does not match with those of a corresponding item of the gathered data, the data comparing module 1230 determines that the key information of the two items are not matched.

In step S408, the data comparing module 1230 determines an item of the gathered data or the payment data is the item with unmatched key information, and then stores the item in the missing table 1241.

When the data comparing module 1230 determines that the key information of two items are matched, then in step S410, the data comparing module 1230 further identifies whether sale information of the two items are matched. In this embodiment, when the unit price and the material quantity of two items with the matched key information are matched, the data comparing module 1230 determines that the two items are items with the matched key information as well as matched sale information. Otherwise, the data comparing module 1230 determines that the two items are items with the matched key information incorporated with unmatched sale information.

When the data comparing module 1230 determines items with the matched key information and sale information, then in step S416, the data comparing module 1230 marks the items as normal respectively in the gathering table 1221 and the payment table 1222.

When the data comparing module 1230 determines items with the matched key information incorporated with the unmatched sale information, then in step S412, the data comparing module 1230 marks the items as abnormal respectively in the gathering table 1221 and the payment table 1222.

In step S414, the data comparing module 1230 stores the items with the matched key information incorporated with the unmatched sale information in the exception table 1242.

In this embodiment, the data gathering subsystem 1100 is a component of the ERP system, the reconciliation data processing subsystem 1200 is a component of a data warehouse system of the plant, the data gathering subsystem 1100 combines with the reconciliation data processing subsystem 1200 in order to alleviate the burden of the ERP system and make efficient use of the data warehouse system.

Moreover, The account reconciliation system 1200 adopts a difference data buffering technology, which is storing items with unmatched key information in the missing table 1241 and storing items with matched key information incorporated with unmatched sale information in the exception table 1242 to accelerate the reconciliation speed and save a great amount of time.

Further, the list generating module 1120 of the data gathering subsystem 1100 makes full use of the backflush and back incoming function, by which the material accounts list is generated in time for correct and timely gathering.

In addition, the data gathering subsystem 1100 processes the data in two phrases, which is generating the material account list via the list processing module 1110 and storing the material account list in the material list table 1114, then reading the material number from the material list 1114 via the gathered data transmitting module 1130. Therefore, the gathered data module 1130 can transform the plant material number to the client material number for further automatic reconciliation between the gathered data and the payment data.

Furthermore, the account reconciliation system 1000 also provides a data inquiring function via the inquiring and analyzing module 1250.

While embodiment and application of this invention have been shown and described, it should be apparent to those skilled in the art having the benefit of this disclosure that many more modifications other than those mentioned above are possible without departing from the invebtive concepts herein. The invention, therefore, is not to be restricted other than by the scope and spirit of the appended claims.

What is claimed is:

1. A system for account reconciliation communicating with a shop floor control (SFC) system and a client system, the system for account reconciliation comprising:
a data gathering subsystem for gathering data; and
a reconciliation data processing subsystem, comprising:
a data importing module for importing the gathered data from the data gathering subsystem, and retrieving payment data from the client system, the gathered data and the payment data comprising key information and sale information on different items; and
a data comparing module for comparing the gathered data with the payment data to differentiate items with unmatched key information and items with matched key information as well as unmatched sale information therein, storing the items with the unmatched key information in a missing table, and storing the items with the matched key information along with unmatched sale information in an exception table.

2. The system of claim 1, wherein the data gathering subsystem comprises:
a storing module for receiving transaction data from the SFC system;
a list generating module for processing material accounts based on the transaction data, and generating a material account list, and storing the material account list in the storing module; and
a gathered data transmitting module for reading the gathered data from the material account list and the transaction data in the storing module, and then transmitting the gathered data to the reconciliation data processing subsystem.

3. The system for of claim 2, wherein the storing module comprises a transaction data table for storing the transaction data, a work order table for storing material number and material quantity of each product, a storage table for storing material information of a plant, a material list table for storing the material account list, a material number mapping table for storing mapping relationships between material numbers of the plant and material numbers of a client, and a unit price table for storing the unit price for each type of material.

4. The system of claim 3, wherein the transaction data comprise a carton identifier (ID), product quantity, a machine model, a work order number, a shipment plant ID, a shipment date, and a sale type.

5. The system of claim 4, wherein the list generating module is provided for reading the transaction data from the transaction data table, and inquiring about the material number and material quantity for each product according to the work order number of the transaction data, and for processing material account in the storage table according to the sale type, the product quantity of the transaction data and the inquired material quantity and material number to generate a material account list.

6. The system of claim 5, wherein the sale type comprises a shipment type and a rejection type; the list generating module is also provided for processing material backflush and back incoming in the storage table, and for generating a material backflush list and a material back incoming list.

7. The system of claim 3, wherein the gathered data transmitting module is provided for reading the carton ID, the shipment plant ID and the sale type from the transaction data table, and reading the material quantity and the material number from the material list table, and for updating the material number according to the material number mapping table, reading the unit price from the unit price table according to a shipment date and the material number, and transmitting the read carton ID, the read shipment plant ID, the sale type, the material number, the material quantity and the unit price to the reconciliation data processing subsystem.

8. The system of claim 1, wherein the reconciliation data processing subsystem further comprises a data storing module comprising a gathering table for storing the gathered data and a payment table for storing the payment data.

9. The system of claim 8, wherein the reconciliation data processing subsystem further comprises a data buffering module for storing the missing table and the exception table, and feeding back difference data of the missing table and the exception table to the data gathering subsystem.

10. The system of claim 9, wherein the reconciliation data processing subsystem further comprises an inquiring and analyzing module for providing data inquiring function which includes inquiring source data from the data storing module and the difference data from the data buffering module.

11. The system of claim 1, wherein the key information of the gathered data and the payment data comprise a carton ID, a shipment plant, a sale type and a material number; the sale information of the gathered data and the payment data comprises a unit price and a material quantity.

12. A method for account reconciliation, comprising the steps of:
initiating data gathering via a data gathering subsystem;
importing gathered data via a reconciliation data processing subsystem;
importing payment data via the reconciliation data processing subsystem;
comparing the gathered data with the payment data via the reconciliation data processing subsystem to differentiate items with unmatched key information and items with matched key information as well as unmatched sale information;
storing items with the unmatched key information in a missing table; and
storing items with the matched key information incorporated with unmatched sale information in an exception table.

13. The method of claim 12, wherein the generating step comprises:
receiving transaction data from a Shop Floor Control (SFC) system;
processing a material account based on the transaction data to generating a material account list; and
reading the gathered data from the transaction data and the material list, and transmitting the gathered data to the reconciliation data processing subsystem.

14. The method of claim 13, wherein the data gathering subsystem stores a transaction data table for storing the transaction data, a work order table for storing material number and material quantity of each product, a storage table for storing material information of a plant, a material list table for storing the material account list, a material number mapping table for storing mapping relationships between material numbers of the plant and material numbers of a client, and a unit price table for storing the unit price for each type of material.

15. The method of claim 14, wherein the transaction data comprises a carton ID, product quantity, a machine model, a work order number, a shipment plant ID, a shipment date and a sale type.

16. The method of claim 15, wherein the processing and generating steps comprises:
reading the transaction data from the transaction data table;
inquiring the material number and material quantity for each product in the work order table; and
processing the material account to generating a corresponding material account list according to the sale type, the product quantity of the transaction data and the inquired material quantity and material number in the storage table; wherein generating a corresponding material account table comprises generating a material backflush list and generating a returned material list.

17. The method of claim 16, wherein the step of reading the gathered data from the transaction data and the material list, and transmitting the gathered data to the reconciliation data processing subsystem comprises:
reading the carton ID, the shipment plant ID and the sale type from the transaction data table;
reading the material number and the material quantity form the material list table;
updating the material number according to the material number mapping table;
reading the unit price from the unit price table according to the shipment date and the material number; and
transmitting the read carton ID, the shipment plant ID, the sale type, the material number, the material quantity and the unit price to the reconciliation data processing subsystem.

18. The method of claim 12, wherein the reconciliation data processing subsystem comprises a gathering table for storing the gathered data and a payment table for storing the payment data.

19. The method of claim 12, wherein the key information of the gathered data and payment data comprise a carton ID, a shipment plant ID, a sale type and a material number, the sale information comprises a unit price and material quantity.

20. A method for account reconciliation, comprising the steps of:
gathering account-related data in a system;
importing said data gathered in said system;
importing payment data in said system from a client system;
comparing said data gathered in said system with said payment data to differentiate items with unmatched key information from items with matched key information;
identifying items with unmatched sale information out of said items with matched key information;
storing said items with unmatched key information in a missing table; and storing said items with unmatched sale information out of said items with matched key information in an exception table independent and different from said missing table.
